(19) United States
(12) Patent Application Publication
(10) Pub. No.: US 2007/0067539 A1
(43) Pub. Date: Mar. 22, 2007

(54) Enhanced CCID circuits and systems utilizing USB and PCI functions

(76) Inventor: Neil Morrow, San Jose, CA (US)

Correspondence Address: WAGNER, MURABITO & HAO, LLP, TWO NORTH MARKET STREET, THIRD FLOOR, SAN JOSE, CA, 95113, US

(21) Appl. No.: 11/225,145

(22) Filed: Sep. 12, 2005

(51) Int. Cl. G06F 13/14

(52) U.S. Cl. 710/305

(57) ABSTRACT

The present invention provides an enhanced controller. The enhanced controller comprises a USB (Universal Serial Bus) based CCID (Chip Card Interface Device) controller which is integrated with a PCI (Peripheral Component Interconnect) or PCI Express based exchangeable media card controller. The two controllers are coupled by a shared terminal to share functions of both the USB based CCID controller and the PCI based exchangeable media card controller, thus provides benefits over the discrete controllers.

### FIELD

The present invention relates to the design and manufacturing of chip card (CC) controllers and exchangeable media controllers, and the systems that utilize these controllers. Specifically, the present invention relates to USB (Universal Serial Bus) based chip card controllers using the USB based CCID (Chip Card Interface Device) protocols, specifically those chip card controllers integrated with other PCI (Peripheral Component Interconnect) and PCI Express based exchangeable media controllers.

### BACKGROUND

The USB industry group promotes specific device protocol specifications for common USB device classifications. The Chip Card Interface Device (CCID) protocol was created as a device class specification for USB based chip card (a.k.a. smart card) readers. In general, prior art chip card readers require a vendor-specific device driver. The proliferation of CCID provides native operating support to chip card readers, which provides a common test and after-market support environment.

Generally, a CCID reader provides D+ and D− signals and clock source terminals for a USB connection. In some cases, a common crystal connection is provided, and an internal phase locked loop (PLL) provides the USB timing reference. In other cases, typically motherboard configurations, a 48 MHz clock source is provided by a system resident clock generation circuit.

Several computer systems include a Peripheral Component Interconnect (PCI) device controlling connectivity to exchangeable media; for example, PCMCIA/PC Card media, SmartMedia, xD-Picture Card, MultiMediaCard (MMC), Secure Digital (SD) and SDIO, and Memory Stick and MS-Pro. There is a wide range of supported clock rates with respect to media type. For example, Memory Stick has a clock range up to 20 MHz, and MS-Pro ranges to maximum 40 MHz. One version of SD has a maximum clock rate of 25 MHz, and a new high-speed SD mode supports 50 MHz. When a clock is sourced by the exchangeable media controller to the media card, it is generally used as a timing reference, and has a large impact on data throughput.

There are two alternate solutions in the prior art. The first alternate solution comprises two discrete components: a USB based CCID reader and a PCI based exchangeable card controller. The second alternate solution integrates the CC controller into a PCI device, such as the integration of a CC controller into a PC Card controller as learned in U.S. Pat. No. 6,470,284. In this case, the CC controller is not a CCID protocol, since CCID by definition is a protocol bound to the USB bus interface.

The first alternate solution has the disadvantage of increased board area to accommodate two components, as well as other disadvantages associated with increased component count such as increased supply chain costs. Another disadvantage is the lack of a convenient BIOS interface to configure or control the chip card reader. The USB bus controller is difficult to utilize in a pre-boot environment (i.e. the BIOS environment that typically initializes the system and loads the user's operating system).

The first alternate solution also lacks the clock source flexibility of each individual controller. For example, the PCI based exchangeable card controller will typically only have a 33 MHz clock source. However, for some exchangeable card specifications, such as Secure Digital (SD) Physical Specification v1.1, a clock rate of up to 50 MHz is accepted, providing much higher data throughput than a 33 MHz clock rate. The USB clock for the CCID reader is typically sourced by a system-provided 48 MHz clock.

The first or second alternate solution could include additional clock source pins, or advanced phase locked loop (PLL) circuitry to accommodate higher clock rates with a single 33 MHz clock input. However, this can increase the cost of the solution.

As a result, there is a need to develop an enhanced controller system to overcome these disadvantages.

### SUMMARY OF THE INVENTION

According to one embodiment of the present invention there is provided an enhanced controller. The controller invented here comprises at least two integrated controllers. The first is a USB based CCID controller, and the second is a PCI or PCI Express based exchangeable media card controller. The two controllers are coupled by a shared terminal that provides benefits over the discrete controllers. Many embodiments and benefits are discussed here, including improved clock sourcing for the exchangeable media card controller, and improved convenience for BIOS-level chip card access and controller configuration.

In summary, two separate and unrelated components are integrated, and both are improved in the process. The invention here benefits from potential system board area and cost savings of integrating the CCID chip card reader with the PCI based exchangeable card controller. The invention benefits from power management enhancements, data throughput enhancements, flexibility-of-use enhancements, and convenience-of-use.

### BRIEF DESCRIPTION OF THE DRAWINGS

FIG. 1 illustrates a diagram of one embodiment of the present invention, wherein power management enhancements are made to a CCID reader, improved by the integration with a PCI based exchangeable media controller.

FIG. 2 illustrates a diagram of one embodiment of the present invention that shares a common 2-slot power switch interface.

FIG. 3 illustrates a diagram of one embodiment of the present invention, wherein PCI accessible registers can be conveniently programmed for pre-boot level chip card control and CCID reader configuration.

FIG. 4 illustrates a flow diagram of a pre-boot authentication implemented by the PCI accessible registers illustrated in FIG. 3, in accordance with one embodiment of the present invention, wherein the authentication uses the chip card interface to authenticate a user during the boot sequence.

FIG. 5 illustrates a diagram of one embodiment of the present invention that shares a common 1-slot power switch interface, wherein the embodiment includes logic that enables the single socket interface for chip cards and/or an alternate exchangeable media card.

### DETAILED DESCRIPTION

Reference will now be made in detail to the preferred embodiments of the present invention, an enhanced CCID (Chip Card Interface Device) circuits and systems utilizing USB (Universal Serial Bus) and PCI (Peripheral Component Interconnect) functions, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments of the present invention are implemented on controller logic. For instance, the controller logic is a USB based controller logic such as a chip card controller logic, and a PCI or PCI Express based controller logic such as a media card controller logic, and the like. These logic are operable for configuring USB based cards and PCI based cards. In one embodiment, the controller system includes a controller couple to a bus and another controller coupled to another bus. These two controllers are integrated. The controllers can share functions and terminals each other. The controller system also includes at least one shared terminal to coupling these two controllers.

Some portions of the detailed description which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “utilizing,” “integrating,” and “sharing,” or the like, refer to the actions and processes of a computer system, or similar electronic computing device, including an embedded system, that manipulates and transforms data represented as physic (electronic) quantities within the computer system's registers and memories into other data similarly represented as physical quantities within the computer system memories or registers or other such information storage, transmission or display devices.

Accordingly, various embodiments of the present invention disclose enhanced CCID circuits and systems utilizing the USB and PCI functions. Embodiments of the present invention provide for potential system board area and cost savings by integrating the CCID chip card reader with the PCI based exchangeable card controller. The present invention provides several additional ways to decrease pin count and potentially die area by sharing terminals and functions between an integrated USB base CCID reader and a PCI based media controller. The present invention provides for power management enhancements, data throughput enhancements, flexibility-of-use enhancements, and convenience-of-use.

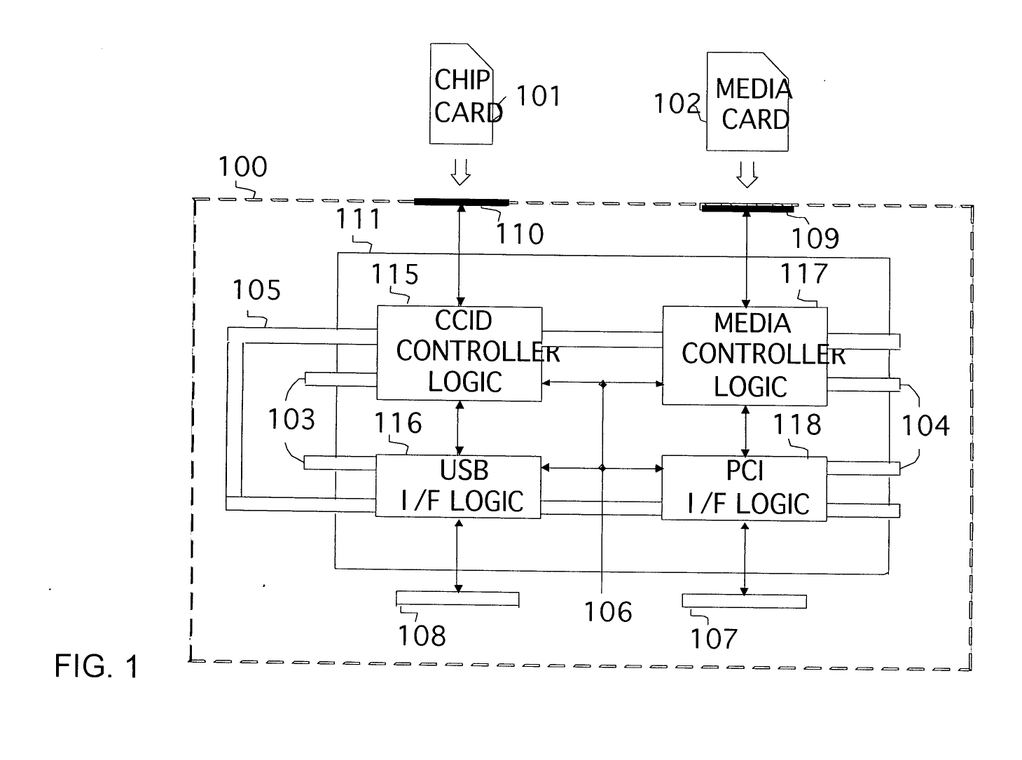

FIG. 1 illustrates a diagram of one embodiment of the present invention, wherein power management enhancements are made to a CCID reader (111), improved by the integration with a PCI based exchangeable media controller. The USB based CCID protocol is native across a variety of operating systems. Thus, no vendor-specific device driver is necessary to operate chip cards when using the CCID programming method.

The enhanced CCID reader (111) includes a PCI interface logic (118) and a media controller logic (117) associated with the exchangeable media (102) connectivity, plus USB interface logic (116) and CCID controller logic (115) associated with the chip card (101) connectivity. Media cards (102) and chip cards (101) interface to the computer system (100) through standard connector (109) and connector (110).

In the preferred embodiment, pin-count savings is achieved by sharing a system power management reset signal input (106) common to PCI devices. The shared reset signal synchronizes the power state of the CCID controller and the media controller. Furthermore, an auxiliary power supply illustrated as a shared power plane (105) in FIG. 1 is used in the preferred embodiment for auxiliary power. A separate power supply (104) provides voltage to the PCI interface logic. For example, the auxiliary power supply is a 3.3V power source available when the PCI function is placed into a D3 low-power state. In some embodiments, a third power source (103) is used to supply power to the USB interface logic and/or the CCID controller logic.

It is common to provide separate power supplies for each bus interface on a device, as an advanced operating system may power off bus interfaces independently to save power. For example, in this invention the PCI bus connection (107) may be powered off independent of the state of the USB bus connection (108).

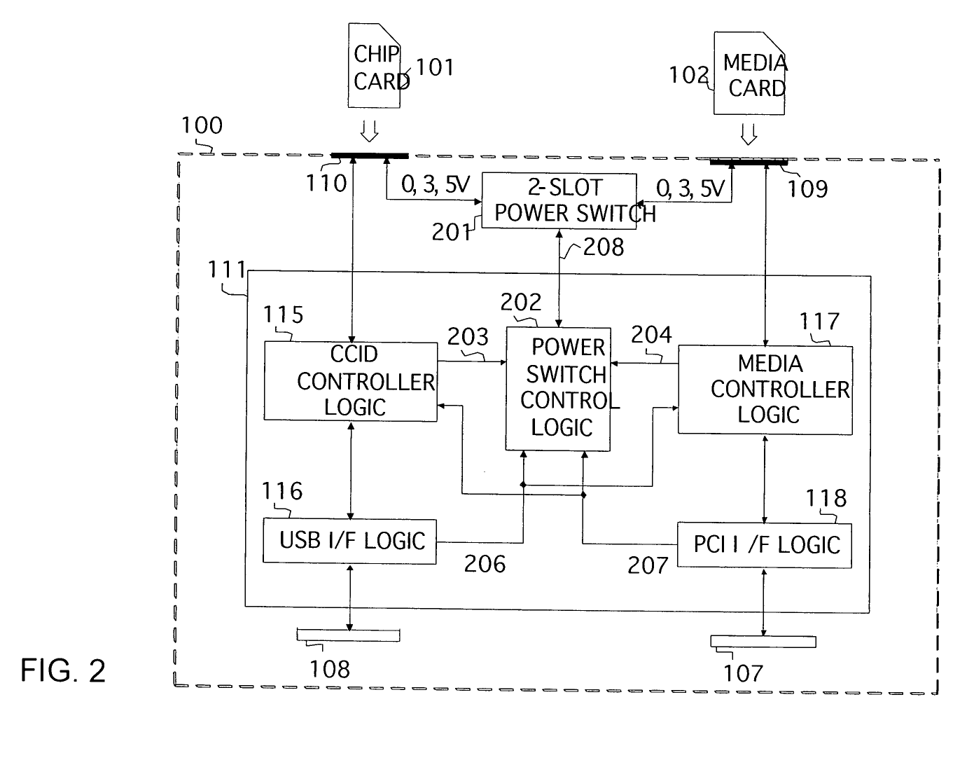

FIG. 2 illustrates a diagram of one embodiment of the present invention which shares a common 2-slot (a.k.a. socket) power switch interface (208). The 2-slot power switch interface (208) couples to a 2-slot power switch (201). The 2-slot power switch (201) generally provides 0V, 3V, and 5V power to the chip card (101) through the chip card connector (110). The 2-slot power switch also provides 0V, 3V, and 5V power to the media card (102) through the media card connector (109).

The preferred embodiment of the enhanced CCID reader (111) includes shared power switch control logic (202) that interfaces to both the CCID controller logic (115) and the media controller logic (117). The shared power switch control logic (202) controls the 2-slot power switch (201) to supply power to the chip card (101) and the media care (202) through the power switch interface (208). In this case, the media controller logic (117) communicates media card power requirements via an internal interface (204) in the same time domain as the power switch control logic (202), and the CCID controller logic (115) communicates chip card power requirements via an internal interface (203) in the different time domain as the power switch control logic (202). In the preferred embodiment, there is timing synchronization logic included in the power switch control logic (202) to accommodate this transformation from the USB reference clock domain into the PCI clock domain.

In the preferred embodiment, a resident clock generation circuit provides a 48 MHz clock to the enhanced CCID reader (111) for the USB timing reference (206). This 48 MHz USB timing reference (206) is utilized by the media controller logic (117), as illustrated in FIG. 2, enabling improving throughput. This 48 MHz USB timing reference (206) may also be used for timing reference to power control logic (210). The 48 MHz clock is either generated by USB I/F logic (116) or directly input by external source not illustrated. Alternate embodiments may generate 48 MHz or a derivative through a crystal connection and an internal PLL.

This embodiment improves the clock source flexibility of each individual controller. For example, the PCI based exchangeable card controller will typically only have a 33 MHz clock source. However, for some exchangeable card specifications, such as Secure Digital (SD) Physical Specification v1.1, a clock rate of up to 50 MHz is accepted, providing much higher data throughput than a 33 MHz clock rate. The preferred embodiment here uses the 48 MHz USB timing reference (206) as a clock source to the exchangeable media controller logic for high-speed SD mode, which supports up to 50 MHz clock rate, and utilizes a divide-by-two circuit to provide a 24 MHz clock for the typical SD card. These clock rates provide significant throughput improvement over utilizing standard 33 MHz PCI clock for high-speed SD clock and a simple divide-by-two solution of 16.5 MHz for a typical SD card.

Alternately, FIG. 2 also illustrates a PCI clock (207) connection to the CCID controller logic (115). In the preferred embodiment, a PCI clock (207) is used as a timing reference for the power switch control logic (202). The PCI clock input also can be used to provide alternate timing references for the chip card interface (110).

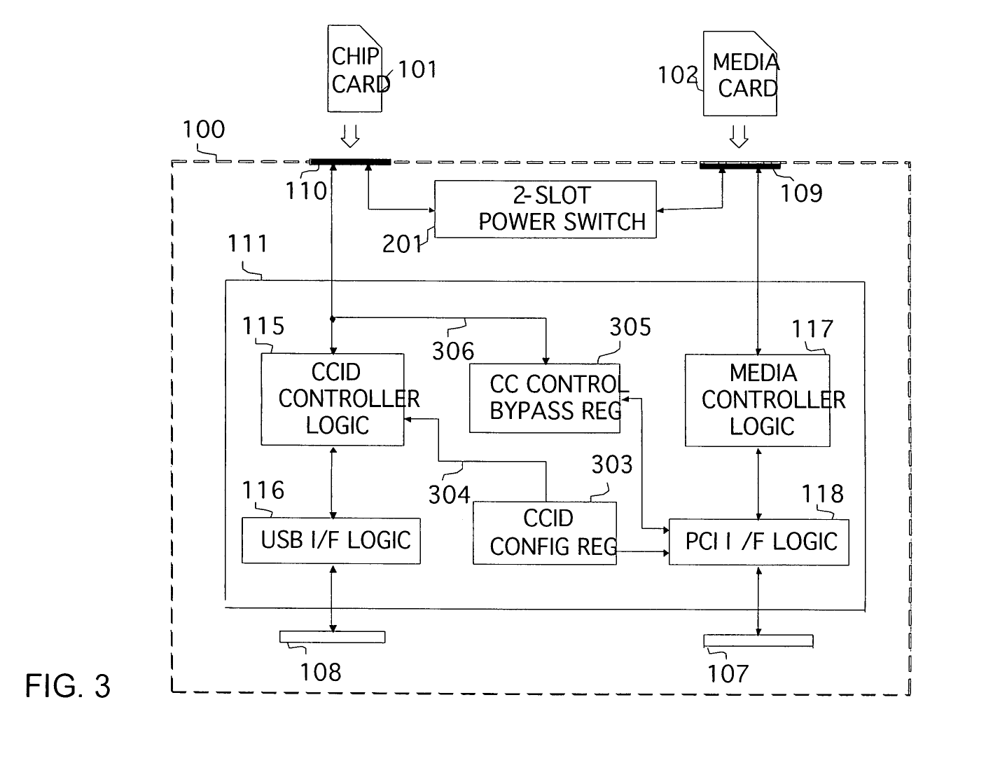

FIG. 3 illustrates PCI accessible registers that can be conveniently programmed for pre-boot level chip card control and CCID reader (111) configuration. In the preferred embodiment, the enhanced CCID reader (111) includes the two registers as illustrated in FIG. 3: CCID Configuration Register (303) (CCID CONFIG REG) and CC Control Bypass Register (305) (CC CONTROL BYPASS REG).

The CCID Configuration Register (303) is accessible through the PCI interface. In the preferred embodiment, the register is addressed by PCI Configuration cycles, and resides in the PCI vendor-specific header. The register contains bits that control settings in the CCID controller logic (115) and/or USB Interface logic (116). For example, bits in this register may set the base clock rate for the chip card (101), as a divided multiple of the 48 MHz timing reference. Other configuration settings may include input/output drive strength setting; for example, controlling the drive strength of outputs on a 4 mA granularity. Other configuration settings may include settings for ISO7816-10 synchronous card support. These settings are provided through a register that, in the preferred embodiment, supports an internal interface (304) to the CCID controller residing in a different time domain; that is, the register itself provides a synchronization barrier, and no PCI clock is needed by the CCID controller logic to determine the value of the settings provided via the CCID Configuration Register.

The USB based interface to the CCID controller logic (115) is generally not a convenient BIOS interface to configure the chip card reader. The USB bus controller is difficult to utilize in a pre-boot environment (i.e. the BIOS environment that typically initializes the system and loads the user's operating system). The invention illustrated in FIG. 3 provides a convenient programming interface through the PCI connection for BIOS interface to configure the chip card reader. BIOS software generally utilizes the PCI bus with ease.

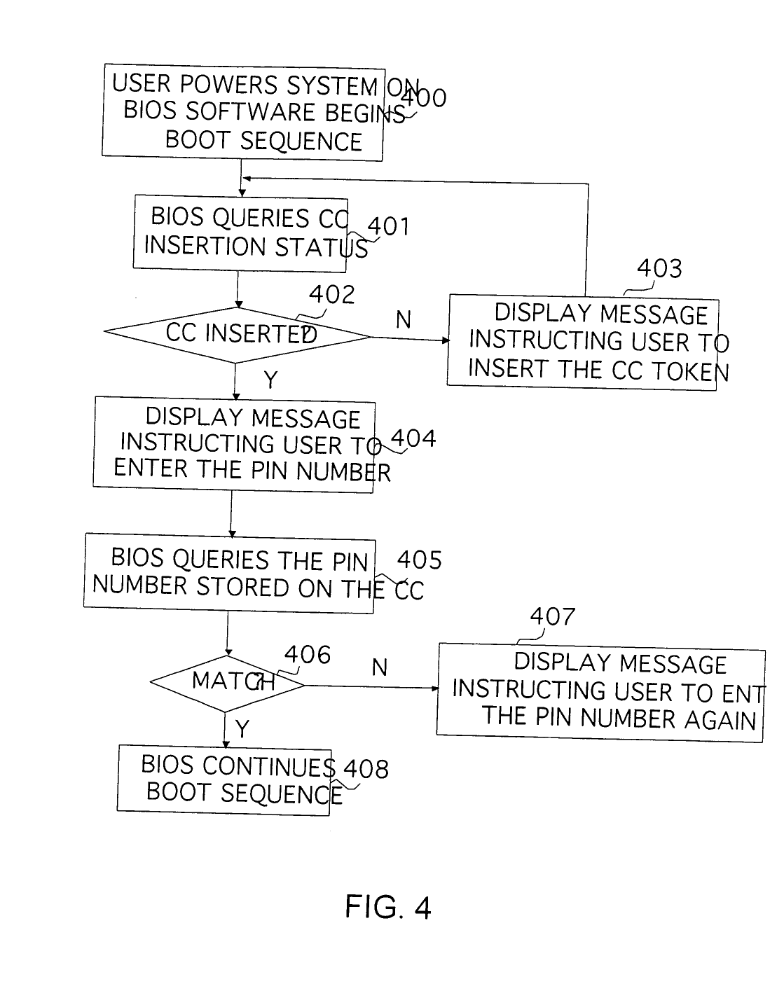

The CC Control Bypass Register (305) is included in the preferred embodiment to allow BIOS software, or application specific software, to bypass the CCID controller logic and directly control the chip card interface. The preferred embodiment uses this register for pre-boot authentication, described in FIG. 4. In the preferred embodiment, the register is addressed by PCI configuration cycles, and resides in the PCI vendor-specific header. The register contains bits that control the chip card interface signals. In the preferred embodiment, this register is connected directly to the input/output connections (306), although an alternate embodiment may route this register to a modified CCID Controller logic that routes the bypass control to the input/output connections appropriately.

Since the pre-boot authentication is accomplished prior to the load of a user operating system, the BIOS handles pre-boot algorithms, such as those described in FIG. 4. The CC Control Bypass Register (305) provides a convenient mechanism for BIOS to perform the flow given in FIG. 4, or an alternate pre-boot authentication flow, without initializing the USB controller and coding complex and lengthy methods of accomplishing the task via USB.

FIG. 4 illustrates a flow diagram of a pre-boot authentication, which uses the chip card interface to authenticate a user during the boot sequence. When system powers on, BIOS software begins boot sequence (400).

BIOS queries chip card insertion status (401) which indicates whether a chip card is inserted or not. BIOS checks whether a chip card has been inserted (402). If no chip card has been inserted, BIOS will display a message instructing the user to insert a chip card again (403).

After BIOS has checked that a chip card has been inserted properly, BIOS will display a message instructing the user to enter a pin number of the chip card (404). After user enters the pin number of the chip card, BIOS queries this pin number with the pin number stored on the chip card (405). If the pin number the user entered matches that on the chip card, BIOS continues boot sequence (408). If the pin number the user entered does not match that on the chip card, BIOS will display a message instructing user to enter a pin number again (407).

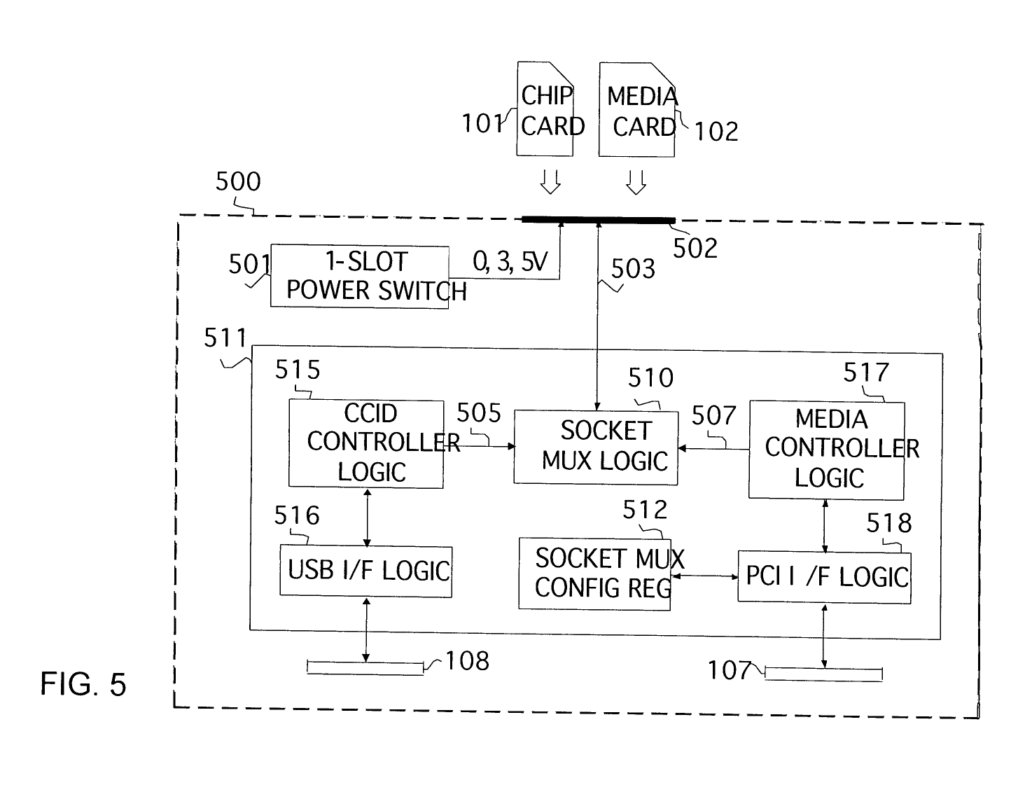

FIG. 5 illustrates an alternate embodiment of the present invention which shares a common 1-slot (a.k.a. socket) power switch interface (503). The embodiment uses a socket multiplexing (i.e. mux) logic (510) which interfaces to both the CCID controller logic (515) and the media controller logic (517) to configure the 1-slot power switch interface (503) to operate in either chip card mode or a mode controlled by the exchangeable media controller.

When selected to function in chip card mode, internal signals (505) from the CCID controller logic (515) are routed through the socket multiplexing logic (510) to the connector interface (502). When selected to function in a mode controlled by the exchangeable media controller, internal signals (507) from exchangeable media controller logic (517) are routed through the socket mux logic (510) to the connector interface (502). The internal signals include Smart Card CLOCK, I/O, and RESET signals multiplexed with a variety of media card signals, that include MEDIA_CLOCK, MEDIA_DATA[3:0], MEDIA_COMMAND, MEDIA_BUS_STATE, depending on the type of media interface. Smart Card terminal signals are specified by ISO7816. Media card interface is specified by Sony's Memory Stick Standard, SD Memory Card Standard, SSFDC Standard, Multi Media Card Standard, xD-Picture Card Standard, etc. When a card is inserted, the enhanced CCID reader (511) will sense which card is present and update the socket mux configuration register (512) to enable appropriate path (500) or path (501). The config reg (512) makes the interface (503) enabled for chip card protocol or media card protocol. If chip card protocol is chosen, then signals (505) map to the interface (503). If media card protocol is chosen, then signals (507) map to the interface (503).

In this alternate enhanced CCID reader (511), a single power switch (504) is used to route 0V, 3V, or 5V power to the socket/connector interface (502). In some new exchangeable media specification, it should be noted that a 1.8V power supply is gaining popularity, and is a natural extension to the supply power capability.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible.

1. An integrated interface controller comprising:
a first host bus interface;
a first controller logic to control a first card interface, wherein said first controller logic utilizes a first protocol specific to said first host bus interface;
a second host bus interface;
a second controller logic to control a second card interface, wherein said second controller logic utilizes a second protocol specific to said second host bus interface; and
at least one shared terminal between said first controller logic and said second controller logic to share functions between said first controller logic and said second controller logic.

2. The integrated interface controller of claim 1, wherein said first host bus interface is a PCI (Peripheral Component Interconnect) based bus interface, and said first protocol specific to said first host bus is a PCI based protocol.

3. The integrated interface controller of claim 1, wherein said second host bus interface is a USB (Universal Serial Bus) based bus interface, and said second protocol specific to said second host bus interface is a USB based CCID (Chip Card Interface Device) protocol, thus no vendor-specific device driver is needed.

4. The integrated interface controller of claim 1, wherein said at least one shared terminal comprises a power switch interface coupling to a power switch device which supplies power to said first card interface and said second card interface.

5. The integrated interface controller of claim 1 further comprises a power switch control logic, coupling to said first controller logic and said second controller logic, configured to control said power switch device through said power switch interface, thus said first controller logic and said second controller logic can communicate power requirements to said power switch logic via internal interfaces

6. The integrated interface controller of claim 5, wherein said power switch control logic further comprises a timing synchronization logic to accommodate transformation of clock domain between said first controller logic and said second controller logic.

7. The integrated interface controller of claim 1, wherein said at least one shared terminal comprises an auxiliary power supply input to provide auxiliary power to said first controller logic and said second controller logic.

8. The integrated interface controller of claim 1, wherein said at least one shared terminal comprises a terminal used to synchronize power management states of said first controller logic and said second controller logic.

9. The integrated interface controller of claim 1, wherein said at least one shared terminal comprises a clock input to synchronize states of said first controller logic and said second controller logic.

10. The integrated interface controller of claim 9, wherein said clock input comprises a USB clock for said second controller logic used as a clock source to said first controller logic to realize clock source flexibility.

11. The integrated interface controller of claim 9, wherein said clock input further comprises a PCI clock which provides alternate timing references for said second card interface.

12. The integrated interface controller of claim 1 further comprises registers programmed through said first host bus interface used for said second controller logic control in a pre-boot environment and for configuration of said second controller logic.

13. The integrated interface controller of claim 12, wherein said registers comprise a bypass register, configured to allow BIOS to bypass said second controller logic and directly control said second card interface.

14. An integrated interface controller comprising:
a first host bus interface coupled to a first controller logic;
a second host bus interface coupled to a second controller logic; and
a shared terminal coupling said first controller logic and said second controller logic for sharing functions between said first controller logic and said second controller logic.

15. The integrated interface controller of claim 14, wherein said first host bus interface is a PCI (Peripheral Component Interconnect) based bus interface.

16. The integrated interface controller of claim 14, wherein said second host bus interface is a USB (Universal Serial Bus) based bus interface.

17. The integrated interface controller of claim 14, wherein said sharing functions includes sharing communication protocols of said first controller logic and said second controller logic.

18. The integrated interface controller of claim 14, wherein said sharing functions includes sharing power supplies of said first controller logic and said second controller logic.

19. The integrated interface controller of claim 14, wherein said sharing functions includes sharing clock inputs of said first controller logic and said second controller logic.

20. The integrated interface controller of claim 14, wherein said shared terminal is a single socket power switch interface coupling to a single power switch which provides auxiliary power supply to a single socket card interface.

21. The integrated interface controller of claim 14 utilizes a multiplexing logic to enable said single socket power switch interface to operate in a first card mode controlled by said first controller logic or an alternate second card mode controlled by said second controller logic.

22. A method to enhance a controller system comprising:
utilizing a first bus based controller;
integrating a second bus based controller into said first bus based controller; and
sharing terminals and functions between said first bus based controller and said second bus based controller.

23. The method of claim 19, wherein said first bus based controller is a USB (Universal Serial Bus) based CCID (Chip Card Interface Device) reader to operate a USB based card, thus no vendor-specific device driver is needed_ and said second bus based controller is a PCI (Peripheral Component Interconnect) based controller configurable for PCI based card operation integrated into said USB based CCID reader.

24. The method of claim 19 further comprising:
sharing a power switch interface with terminals used by said PCI based controller to save pin count and die area;
sharing multiplexing chip card input/output terminals with terminals used by said PCI based controllers to save pin count and die area;
sharing power management interfaces; and
sharing an auxiliary power source to provide auxiliary power to said CCID reader and said PCI based controller.

25. The method of claim 21 further comprising:
sharing a USB clock for said CCID reader as a clock source to said PCI based controller to realize clock source flexibility for said CCID reader and said PCI based controller, thus improving throughput.

26. The method of claim 21 further comprising:
utilizing said PCI based controller to provide a convenient programming interface for BIOS interface to configure and control said CCID reader directly.
